(19) United States
(12) Patent Application Publication
(10) Pub. No.: US 2012/0085068 A1
(43) Pub. Date: Apr. 12, 2012

(54) MACHINE FOR APPLICATION OF CAPS ON CONTAINERS SUCH AS BOTTLES AND THE LIKE

(76) Inventor: Sergio Cirio, Canelli (Asti) (IT)

(21) Appl. No.: 13/243,832

(22) Filed: Sep. 23, 2011

(30) Foreign Application Priority Data
Oct. 6, 2010 (IT) TO2010A000817

(51) Int. Cl. B67B 3/20

(52) U.S. Cl. 53/317

(57) ABSTRACT

A machine for application of caps on containers such as bottles and the like having a neck with a threaded top end, comprising at least one head for application of caps and at least one gripper designed to grip the neck of the containers during application of the caps. Said at least one gripper is mobile in a vertical direction between a raised position and a lowered position, wherein elastic means are present for pushing the gripper elastically towards the raised position and wherein in the lowered position the gripper rests on a resting plate so that at least part of the axial force applied by said head on the cap is discharged on said resting plate.

### CROSS-REFERENCE TO RELATED APPLICATIONS

This application claims benefit of Italian patent application serial number TO2010A000817, filed Oct. 6, 2010, which is herein incorporated by reference.

### BACKGROUND OF THE INVENTION

1. Field of the Invention

The present invention relates to a machine for application of caps on containers such as bottles and the like having a neck with a threaded top end.

The present invention can be used for application of non-pre-threaded metal caps or else for application of threaded caps made of plastic material.

Machines for application of non-pre-threaded caps are equipped with one or more heads that apply the non-pre-threaded caps on the threaded end of the containers and deform plastically the side wall of the caps by means of an operation of rolling to form the thread of the cap in place.

Machines for application of threaded caps are equipped with screwing heads that bestow upon the caps a helical movement with a pitch equal to the pitch of the thread of the caps.

2. Description of the Related Art

During application of a cap on a container, the cap must be pressed on the top end of the container with an axial force. Said axial force is relatively high in the case of non-pre-threaded caps since before carrying out rolling of the cap it is necessary to carry out compression of a gasket of the cap against the top end of the container. The operation of rolling that deforms the cap plastically to form the thread in place is performed whilst the cap is pressed on the container. In this way, the gasket remains compressed after formation of the thread on the cap.

Non-pre-threaded caps are normally used on glass containers that are able to resist without any risk of failure the considerable axial force with which the caps are pressed on the containers during the rolling step. In machines of a known type, the containers rest on bottom cups, discharged on which is the axial force produced by the rolling heads.

Machines of a known type cannot be used for applying non-pre-threaded caps on easily deformable containers, made for example of thin-walled aluminium. The force of compression with which the heads for applying the caps press the caps on the containers would produce collapse of the containers.

Also known are machines for application of threaded caps on containers made of plastic material, where the containers are withheld by grippers that grip the neck of the containers during the step of screwing of the caps on the threaded end of the containers. In machines of this type, the axial force necessary for screwing the caps on the containers tends to subject the grippers and their pins to flexural stress.

### SUMMARY OF THE INVENTION

The object of the present invention is to provide a machine for application of threaded or non-pre-threaded caps on containers that will avoid the risk of damage to the containers and that will avoid stressing of the grippers and their pins.

According to the present invention, said object is achieved by a machine having the characteristics that form the subject of claim 1.

In the machine according to the present invention, the containers are withheld by grippers that grip the neck of the containers. The grippers are mobile in a vertical direction and, following upon application of the force of compression on the containers, come to rest on a support that receives the axial force applied on the cap. In this way, any flexural stress on the grippers and their pins is avoided.

Thanks to this arrangement it becomes possible to apply non-pre-threaded caps on containers with low resistance to compression, for example ones made of thin-walled aluminium.

The claims form an integral part of the teaching provided herein in relation to the invention.

### BRIEF DESCRIPTION OF THE DRAWINGS

The present invention will now be described in detail with reference to the attached drawings, which are provided purely by way of non-limiting example and in which:

FIG. 1 is an axial cross section of a machine according to the present invention;

FIG. 2 is an enlarged view of the part indicated by the arrow II in FIG. 1;

FIG. 3 is a view at a larger scale of the part indicated by the arrow III in FIG. 2;

FIG. 4 is a plan view at a larger scale of the part indicated by the arrow IV in FIG. 2; and

FIG. 5 is a cross section according to the line V-V of FIG. 4.

### DETAILED DESCRIPTION

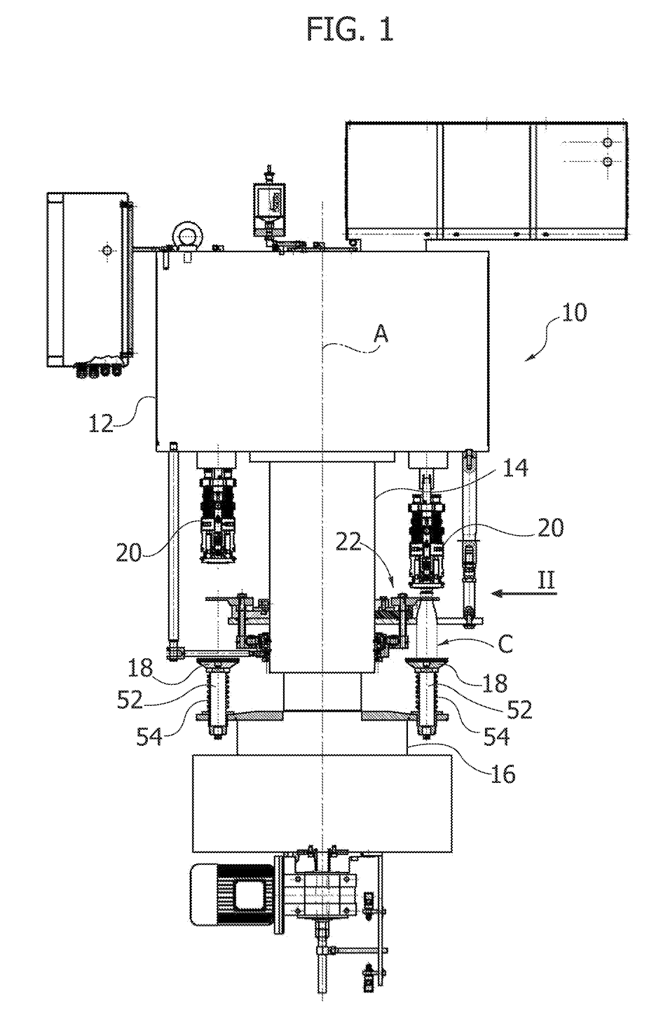

With reference to FIG. 1, designated by 10 is a machine for application of non-pre-threaded caps on containers C, such as bottles and the like. The machine 10 has a carousel structure, which can turn about a vertical axis A and comprises a top part 12, a central column 14, and a bottom base 16.

The bottom base 16 carries a plurality of cups 18, resting on which are respective containers C.

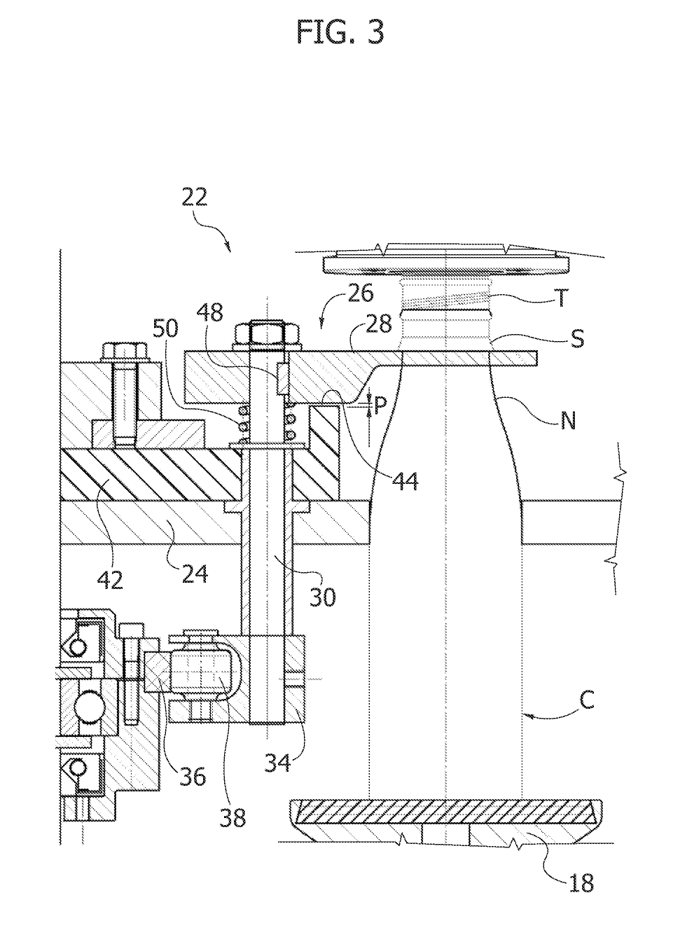

As may be seen in greater detail in FIG. 3, each container C has a neck N with a threaded end T. The neck N can be equipped with a further annular shoulder S situated underneath the threaded end T, already equipped with a first annular shoulder necessary for providing the rim at the bottom of the cap, which, after opening, remains fixed to the bottle.

The top part 12 of the machine 10 carries a plurality of rolling heads 20 (FIG. 1) designed to apply non-pre-threaded caps on the threaded end T of the containers C. In a known way, the heads 20 press the non-pre-threaded caps axially on the top end of the containers C and perform rolling of the side walls of the caps, whilst these are kept pressed on the containers. Rolling consists of two parallel operations: threading and provision of the bottom rim. Threading causes a plastic deformation of the side walls of the caps that forms, in place, a thread mating with the thread T already present on the top end of the containers C. Provision of the bottom rim, through analogous plastic deformation, enables upsetting of the bottom terminal part of the cap underneath the first shoulder, preventing said terminal part from lifting during opening. The structure and operation of the rolling heads 20 can be considered conventional.

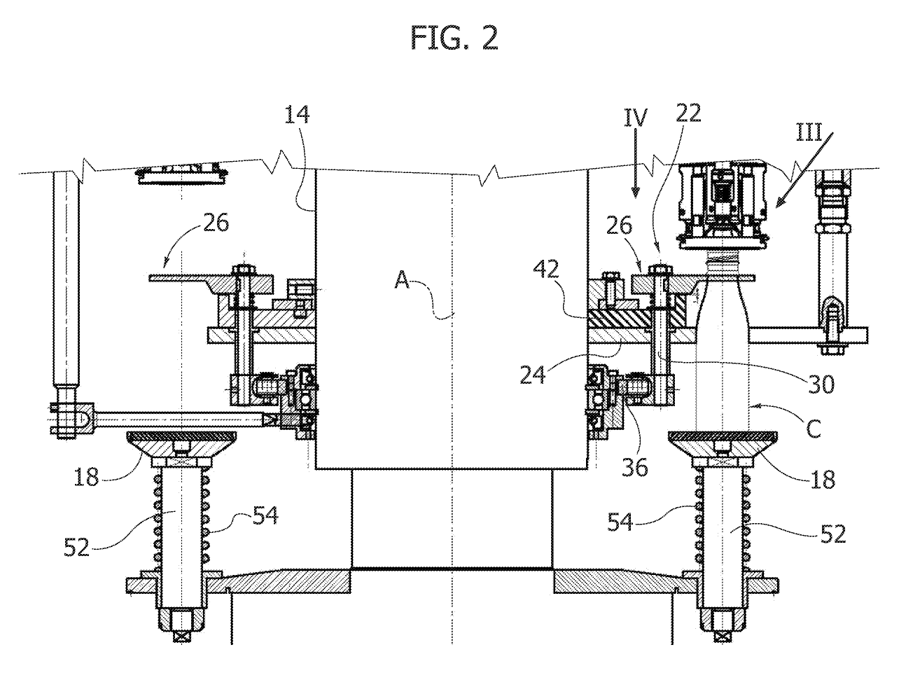

With reference to FIGS. 2 and 3, the central column 14 of the machine 10 carries a gripping assembly 22 designed to support the containers C during the operation of rolling of the caps. The gripping assembly 22 comprises a star wheel 24 that can turn about the axis A and is provided with perimetral seats, in which respective containers C are received. The star wheel 24, in a known way, causes the containers C to advance along a circular path centred on the axis A. The gripping assembly 22 further comprises a plurality of grippers 26 that can turn together with the wheel 24 about the axis A.

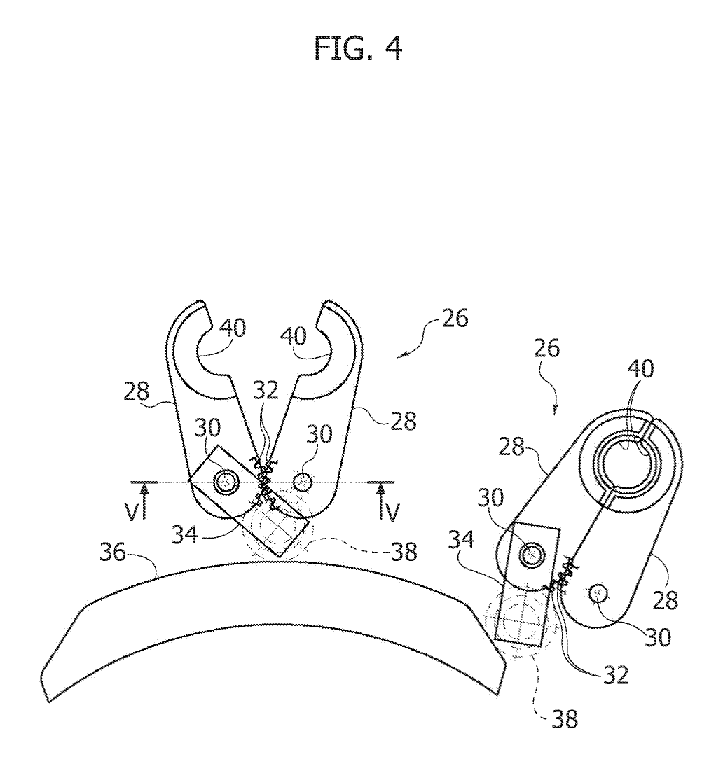

With reference to FIGS. 3, 4 and 5, each gripper 26 comprises two jaws 28 coupled in rotation to respective vertical pins 30. The jaws 28 are mobile between an open position, illustrated in the left-hand part of FIG. 4, and a closed position, illustrated in the right-hand part of FIG. 4. Each gripper 26 is equipped with a mechanism that governs opening and closing of the jaws 28. Said mechanism can assume different configurations. In the example illustrated, the jaws 28 are provided with respective toothed sectors 32 meshing with one another. The pin 30 of one of the two jaws 28 of each gripper 26 is fixed at its bottom end to a lever 34 that co-operates with a stationary cam 36 via a wheel 38. The lever 34 is pushed by an elastic element (not illustrated) towards a position that corresponds to the closed position of the gripper 26. The profile of the cam 36 causes the lever 34 to turn against the action of the elastic element towards a position corresponding to the open position of the gripper 26. Each gripper 26 has a gripping seat 40 designed to grip the neck N of a container C. In the case where the neck N is provided with a shoulder S, said shoulder rests on the top surface of the gripper 26 as illustrated in FIG. 3. The grippers 26 could also be configured for gripping containers C without any shoulder S. In this case, the gripping seat 40 of the grippers 26 could be coated with an elastomeric material to increase the friction on the neck N of the containers C.

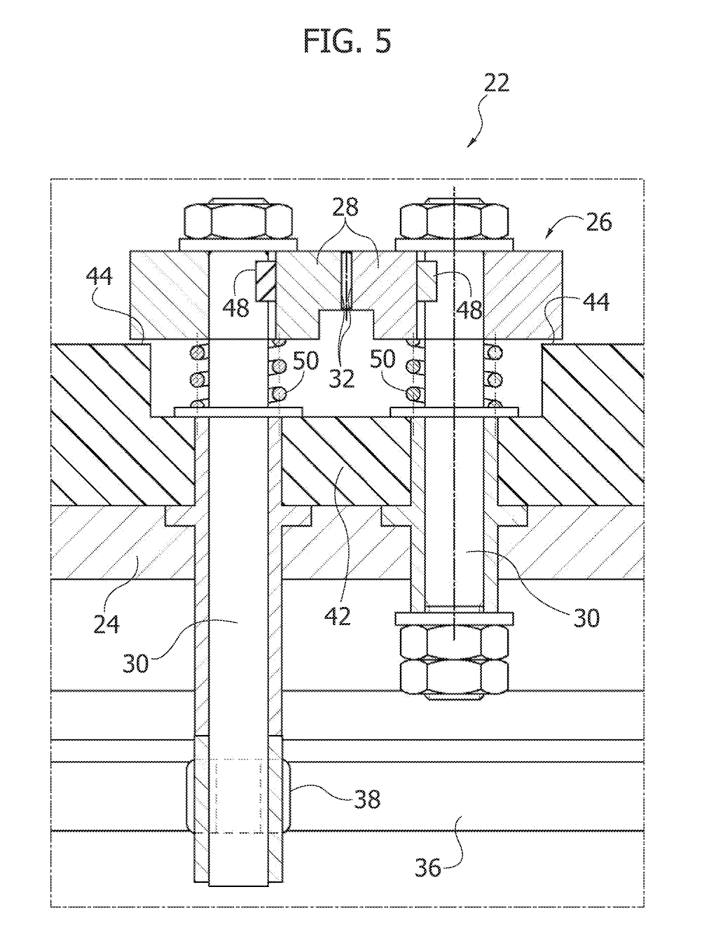

With reference in particular to FIGS. 3 and 5, a supporting plate 42 is set underneath the grippers 22. The supporting plate 42 is preferably set on top of the star wheel 24 and can turn about the axis A together with the wheel 24. The supporting plate 42 has a horizontal contact surface 44 situated between the pins 30 and the area for gripping the containers C.

Once again with reference to FIGS. 3 and 5, the jaws 28 of each gripper 26 are mobile in a vertical direction between a raised position and a lowered position. In the example illustrated, the jaws 28 are connected to the pins 30 by means of respective tabs 48. The jaws 28 are fixed in rotation to the respective pins 30 and are mobile in a vertical direction with respect to the pins 30. Each jaw 28 is associated to a respective elastic element 50 that pushes the jaw 28 towards a raised position. In conditions of rest, with the grippers 26 in the raised position, a play P is provided, for example in the region of 1 mm, between the bottom surface of the jaws 28 and the resting surface 44 of the resting plate 42.

With reference to FIG. 2, the cups 18 carrying the containers C are preferably mobile in a vertical direction. Each cup 18 is carried by a vertically mobile shaft 52. Each shaft 52 is associated to a respective elastic element 54 that pushes the respective cup 28 towards a raised position.

In operation, the containers C move in a circumferential direction resting on the respective cups 18 conveyed by the star wheel 24. The grippers 26 carry out gripping of the neck N of the containers C. After performing gripping of the containers by means of the grippers 26, the heads 20 apply non-pre-threaded caps on the threaded end T of the containers C. During this step, the heads 20 press the caps downwards with a considerable force. The grippers 26 shift downwards under the action of the thrust applied by the heads 20. The grippers 26 come into contact with the resting surfaces 44 of the plate 42. Consequently, the force applied by the heads 20 is discharged on the plate 42 without exerting any stress on the pins 30 of the grippers 26. The cups 18 shift downwards to enable vertical movement of the grippers 26. The body of the containers C underneath the annular shoulder S is subjected to the force with which the heads 20 press the caps axially during the rolling operation, only for the amount deriving from the action of the elastic elements 54.

In this way, it becomes possible to apply non-pre-threaded caps also on containers having a low resistance to compression.

The solution according to the present invention can be advantageously used also for application of threaded caps. In this case, the rest for the grippers prevents a flexural stress on the grippers and on their pins.

Of course, without prejudice to the principle of the invention, the details of construction and the embodiments may vary widely with respect to what has been described and illustrated herein, without thereby departing from the scope of the invention, as defined by the ensuing claims.

1. A machine for application of caps on containers such as bottles and the like having a neck with a threaded top end, comprising at least one head for application of caps and at least one gripper designed to grip the neck of the containers during application of the caps,
wherein said at least one gripper is mobile in a vertical direction between a raised position and a lowered position, wherein elastic elements are provided for pushing the gripper elastically towards the raised position and wherein in the lowered position the gripper rests on a resting plate so that at least part of the axial force applied by said head on the cap is discharged on said resting plate.

2. The machine according to claim 1, further comprising at least one cup, resting on which is the bottom of a respective container, said cup being mobile in a vertical direction and being pushed towards a raised position by a respective elastic element.

3. The machine according to claim 1, wherein said at least one gripper comprises two jaws mobile between an open position and a closed position, said jaws being mobile in a vertical direction on respective pins.

4. The machine according to claim 3, wherein said resting plate has a resting surface for resting of said gripper set between said pins and an area for gripping the containers.

5. The machine according to claim 1, further comprising a plurality of grippers carried by a gripping assembly that can turn about a vertical axis.

6. The machine according to claim 1, wherein said at least one head for application of caps is a head for application of non-pre-threaded caps designed to carry out deformation in place of the caps on the respective threaded ends of the containers.

7. The machine according to claim 1, wherein said at least one head for application of caps is a head for application of threaded caps, designed to carry out screwing of the caps on the respective threaded ends of the containers.
